(19) United States
(12) Patent Application Publication
(10) Pub. No.: US 2022/0347926 A1
(43) Pub. Date: Nov. 3, 2022

(54) BEAM LATTICE DATA IN ADDITIVE MANUFACTURING

(71) Applicant: Hewlett-Packard Development Company, L.P., Spring, TX (US)

(72) Inventors: Alvaro Vinacua Pla, Barcelona (ES); Antonio Chica Calaf, Barcelona (ES); Alex Carruesco Llorens, Sant Cugat del Valles (ES); Jordi Gonzalez Rogel, Sant Cugat del Valles (ES); Oriol Giralt Garcia, Sant Cugat del Valles (ES); Sergio Gonzalez Martin, Sant Cugat del Valles (ES); Joao Hugo Ballesteros Brandao, Barcelona (ES); Pol Martin Garcia, Barcelona (ES); Konstantinos Kazatzis, Barcelona (ES)

(21) Appl. No.: 17/621,124

(22) PCT Filed: Apr. 28, 2020
(86) PCT No.: PCT/US2020/030242

§ 371 Date: Dec. 20, 2021

(30) Foreign Application Priority Data
Jul. 15, 2019 (US) PCT/US2019/041810
Oct. 21, 2019 (US) PCT/US2019/057282

(51) Int. Cl. B29C 64/386; B33Y 50/00; B22F 10/80; G05B 19/4099; G06T 17/20; G06T 19/20

(52) U.S. Cl. CPC B29C 64/386; B33Y 50/00; B22F 10/80; G05B 19/4099; G06T 17/20; G06T 19/20; G05B 2219/49023; G05B 2219/35134; G06T 2219/2008

(57) ABSTRACT

In an example a method includes receiving, at processing circuitry, beam lattice data modelling at least part of a three-dimensional object to be generated using additive manufacturing as a beam lattice. A volumetric data model may be determined from the beam lattice data. Determining the volumetric data model may comprise dividing a volume containing the beam lattice data into sub-volumes and categorising the sub-volumes into (I) interior sub-volumes, which are wholly within a beam of the beam lattice; (ii) exterior sub-volumes which are wholly outside the beams of the beam lattice; and (ii) boundary sub-volumes which partially coincide with a beam of the beam lattice. The method may further comprise subdividing boundary sub-volumes and categorising the subdivided sub-volumes until a threshold volume size of boundary sub-volume is reached.

### BACKGROUND

Additive manufacturing techniques may generate a three-dimensional object on a layer-by-layer basis through the selective solidification of a build material. In examples of such techniques, build material is supplied in a layer-wise manner and a solidification method may include heating the layers of build material to cause melting in selected regions, for example in regions bearing a fusing agent. In other techniques, other solidification methods, such as chemical solidification methods or binding materials, may be used.

### BRIEF DESCRIPTION OF DRAWINGS

Non-limiting examples will now be described with reference to the accompanying drawings, in which:

FIGS. 1, 2 and 3 are flowcharts of example methods for determining a volumetric data model from beam lattice data;

FIG. 4 is a flowchart of an example method of generating an object;

FIGS. 5 and 6 are schematic drawings of example apparatus for use in additive manufacturing; and

FIG. 7 is a schematic drawing of an example processor in conjunction with a machine readable medium.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved using heat in a thermal fusing additive manufacturing operation. This may comprise directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up, coalesces and solidifies upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. In one example such a fusing agent may comprise any or any combination of an infra-red light absorber, a near infra-red light absorber, a visible light absorber and a UV light absorber.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed to reduce or prevent coalescence by, for example, cooling the build material or through some other mechanism. According to one example, a suitable detailing agent may be a formulation commercially referred to as V1Q61A “HP detailing agent” available from HP Inc.

A coloring agent, for example comprising a dye or colorant, may in some examples be used as a fusing agent or a coalescence modifier agent, and/or as a print agent to provide a particular color for the object. Examples of print agents comprising dye based colored ink and pigment based colored ink include inks commercially referred to as CE039A and CE042A available from HP Inc.

As noted above, additive manufacturing systems may generate objects based on structural design data. This may involve a designer designing a three-dimensional model of an object to be generated, for example using a computer aided design (CAD) application. The model may define the solid portions of the object. To generate a three-dimensional object from the model using an additive manufacturing system, the model data may comprise, or can be processed to derive, slices or parallel planes of the model. Each slice may define a portion of a respective layer of build material that is to be solidified or caused to coalesce by the additive manufacturing system. In some examples, the model may be provided as a ‘3MF’ format file, provided by the 3MF consortium, which is an industry consortium working to define a standard 3D printing format

It has been proposed that object models may be provided as mesh models. A mesh model represents an object as a plurality of polygons. For example, a mesh model may represent at least the surface(s) of the object as a plurality of polygons. The polygons may be of a common type, for example comprising triangles. In one example, a mesh model may be specified in terms of the vertices of the polygons (by which edges joining the vertices and polygons enclosed by the edges may be defined).

In one example, a polygon mesh is a triangular mesh representing a surface of the object and each triangle in the mesh has three vertices each defined by their xyz coordinates v0, v1 and v2 (the locations of the polygon vertices in 3D space). While the example of a triangle has been used here, the mesh may be based on a different polygon or polygons, which may in some examples be curved (rather than flat or planar) polygons. In some examples, a mesh model may be a manifold closed surface mesh.

While such polygon mesh models are well suited to specifying some object types, the size of such models increases with the complexity of surface shapes. In some examples, it may be the case that an object to be generated has a complex structure, for example having a lattice-type structure. Modelling such shapes using polygon mesh models is feasible, but the number of vertices utilised in specifying the object shape fully, and therefore the resulting file size, can be large.

There is another type of model which is better suited to characterising such lattice-type forms, a ‘beam lattice’ model. Indeed, the 3MF consortium has extended their specification to include a beam lattice extension, meaning such models may be included in a 3MF file format.

A beam lattice model uses vertices as described above for a polygon mesh model, but instead of being joined by edges, the vertices are joined by beams. The thickness of the beam is determined by defining the radius of the beam at each of the vertices, and the radius varies in a predetermined manner (currently, linearly) between the vertices. If both vertices are associated with the same radius, the beam may be a ‘right cylinder’ whereas if the vertices are associated with different radii, the beam may taper. The shape of the ends of the beams can also be defined by specifying a capping mode or ‘capmode’, and at the time of writing, a selection may be made between hemispherical, spherical or butt ended beams. Additionally, in some examples it may be possible to clip the beam lattice structure with a clipping mesh, to determine which part of the beam lattice structure forms part of a generated object and which does not.

Beam lattices may for example allow precise specification of an pattern in the interior of an object, which have hereto been specified on an algorithmic basis, generally comprising repeated structures such as honeycomb type structures. Such infills may be used to reduce the amount of material solidified, but may have a structure such that the resulting object is strong and/or rigid. Beam lattice models may allow for precise specification of such infill patterns, or other object parts, which may allow properties such as density, strength, rigidity/resilience and the like to be precisely controlled in additive manufacturing. In other examples, they may be suitable to describe some complex shapes in a data-efficient manner.

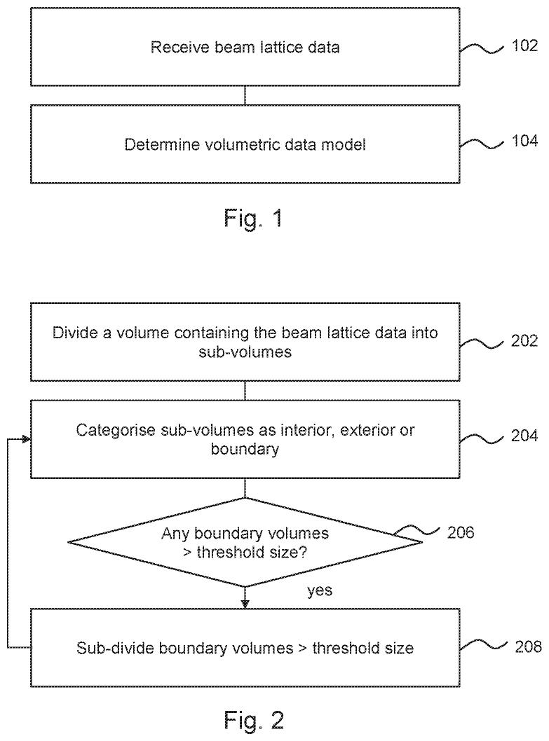

FIG. 1 is an example of a method, which may comprise a computer implemented method of transforming a data model of an object, or of data modelling at least part of an object.

In block 102 the method comprises receiving, by processing circuitry, beam lattice data modelling at least part of a three-dimensional object to be generated using additive manufacturing as a beam lattice. For example, the data may be provided as a 3MF file or the like. The data may be retrieved from a memory or received over a network or the like.

In some examples, the beam lattice may be specified using a plurality of vertices having defined locations in 3D space (for example, relative to an arbitrary origin), and, in association with each vertex, a beam radius. In some examples, at least one capping mode is specified. In some examples, clipping data is provided.

In some examples, while the data comprises a beam lattice structure to model at least a portion of the object, another portion of an object may be specified using another format. For example, the received data may comprise data characterising another object portion as a polygon mesh such as a triangular mesh. In other examples, an object portion may be described using an implicit model (for example being defined mathematically using models such as Non-uniform rational basis spline (NURBS), a constructive solid geometry (CSG) model, or the like.

The received data may model the object in the context of a space, and therefore may explicitly or implicitly describe a volume of space containing the object/beam lattice object portion, including space that is external thereto. For example, the space may comprise a cuboid fully enclosing the object.

Block 104 comprises determining, using processing circuitry (which may be the same processing circuitry as the processing circuitry in block 102), a volumetric data model from the beam lattice data.

As used herein, a volumetric data model is a model of the object as a plurality of sub-volumes, and may for example comprise a file type such as a Shapeways SVX file type, or a modification thereof. In some examples, the files may be Portable Network Graphic (PNG) format files. In another example the file type may be some other suitable file type. In some examples, objects may be modelled as at least one ‘stack’ of ‘two-dimensional images’, each image representing a slice of the object model, and each corresponding to a layer to be manufactured in a layer by layer additive manufacturing process.

In some examples the generated volumetric data model may define a plurality of homogenous sub-volumes, which may in some examples be of different sizes to one another. In some examples, the sub-volumes may be homogenous in the sense that each sub-volume describes a volume of space which is wholly within a solid portion of the object, or is wholly external to a solid portion. Using methods set out below, volumes which span an object boundary may be recursively divided (for example into four for a quadtree model, or into eight for an octree model) until they can be categorised as being internal or external, or until a sub-volume reaches a threshold minimum size. In some examples, rather than (or in addition to) being ‘internal’ or ‘external’, a region may be homogenous in relation to another property, for example a color or the like.

Another type of volumetric model may be a voxelised model. Voxel models also describe an object in terms of sub-volumes, but these sub-volumes are generally of the same size, which may be associated with the intended resolution of object generation. For example, an additive manufacturing apparatus may have a z-resolution, or layer thickness, and a voxel may model a volume of space having a size corresponding to the resolution of a particular additive manufacturing apparatus which it is intended to use in generating an object based on the determined model. For example, a particular additive manufacturing apparatus may have a layer height, or a resolution in the z-axis, of 80 μm and a resolution in the x-axis and y-axis of 21 μm at 1200 dpi or 42 μm at 600 dpi. A quadtree, octree or similar model may be converted to a voxel model by dividing all the sub-volumes which are larger than a voxel into voxel-sized sub-volumes. As the sub-volumes are homogeneous, this may be a relatively simple processing operation.

FIG. 2 sets out the process for determining the volumetric data model in block 104.

Block 202 comprises dividing a volume containing the beam lattice data into sub-volumes. For example, in the case of an octree, block 202 may comprise taking a cuboid virtual volume fully enclosing a space to be occupied by the beam lattice described in the data and dividing this into eight equal portions. The cuboid virtual volume may be referred to as a boundary box in some examples.

Then, in block 204, each of these sub-volumes is categorised as one of (i) an interior sub-volume, which describes a volume which is wholly within a beam of the beam lattice (i.e. a sub-volume which models a volume of space which is entirely contained within a beam of the beam lattice model); (ii) an exterior sub-volume, which describes a volume which is wholly outside the beams of the beam lattice (i.e. a sub-volume which models a volume of space which is entirely free of beams of the beam lattice model); and (iii) a boundary sub-volume which partially coincides with a beam of the beam lattice (i.e. a sub-volume which models a volume of space which is partially—but not wholly—free of beams of the beam lattice model).

Thus, an interior sub-volume models material which is to be solidified in forming part of an object, an exterior sub-volume models a region which is not to form part of an object and a boundary sub-volume describes a region wherein a part of the region is empty of the object while another part models material which is to form part of an object.

Block 206 comprises determining if there are any boundary sub-volumes of greater than a threshold volume size. In some examples, the threshold volume size may be print resolution, or ‘voxel’ size. For example, as set out above, an additive manufacturing apparatus may have a z-resolution, or layer thickness, of 80 μm and a resolution in the x-axis and y-axis of 21 μm at 1200 dpi or 42 μm at 600 dpi. In some examples, the threshold sub-volume may be a sub-volume representing a corresponding volume of space for a given intended resolution of object generation, and is the maximum resolution at which the volumetric model is to be specified, or to put it another way, the minimum sub-volume size to be determined.

If there is at least one boundary sub-volume which is larger than the threshold size (e.g. larger than a print resolution voxel), the method continues to block 208 which comprises subdividing boundary sub-volumes of greater than the threshold size, and the method loops back to block 204. If there are no remaining boundary sub-volumes, the method (or this portion of the method) may end. If there are remaining boundary sub-volumes, but these are all of the threshold minimum size, in some examples the categorisation of ‘boundary’ may remain, or they may be categorised as interior or external on an arbitrary or systematic basis, for example using methods of categorising boundary sub-volumes of the minimum size as discussed below.

Thus the method of FIG. 2 comprises categorising the subdivided sub-volumes until all a category of interior or exterior is determined, or a threshold volume size is reached.

While this example considers the object model as whole, in other examples, portions of the object may be considered in turn.

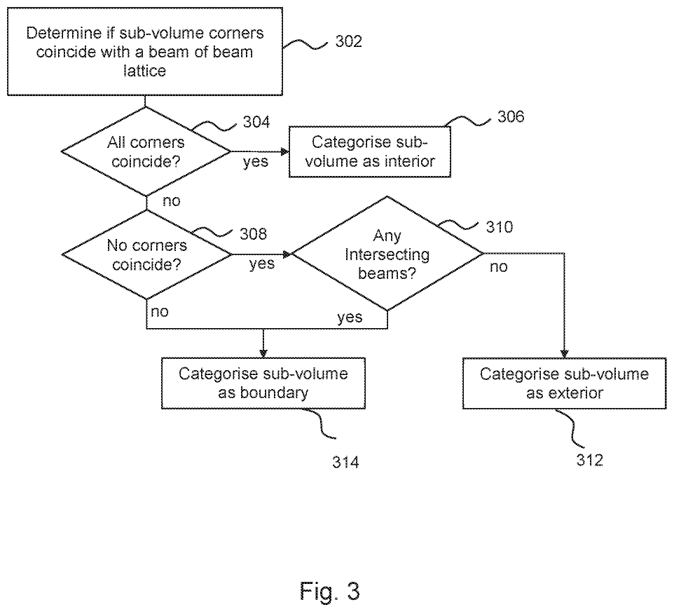

FIG. 3 is an example of a method of carrying out block 204 of FIG. 2, i.e. a method (which may be a computer implemented method) of characterising the sub-volumes. The method may be applied to each sub-volume.

In block 302, the method comprises determining, for each corner of the sub volume, if the corner coincides with a beam of the beam lattice. In other words, a coordinate of a corner of a sub-volume is compared to the volumetric extent of at least one (and in some examples, to each) of the beams of the beam lattice. The sub-volume may be a parallelepiped, for example a cuboid, having eight corners.

In some examples, the corners may be tested against each of the beams. In other examples, a list of ‘candidate’ beams may be defined wherein candidate beams are those which potentially intersect with a sub-volume under inspection, and wherein the list may be a sub-set of the full set of beams. For example, the list of candidate beams considered for a sub-volume may be the beams that intersected the volume from which it was sub-divided, which may be termed a ‘parent’ sub-volume.

To determine if a corner is within a beam, the distance (e.g. a Euclidean distance) between the corner and the beam axis (i.e. a notional line between the vertices of the beam) may be determined, and it may be evaluated whether this distance is less than or equal to the beam radius at this point along the beam, in which case the corner may be determined to be within the beam.

In block 304, it is determined if all the corners are interior to the (same) beam, i.e. all the corners are spaced by less than the beam radius from the same beam axis. If all the corners are within the same beam, the sub-volume is categorised as an interior sub-volume in block 306.

Otherwise, the method proceeds to block 308, in which it is determined if all the corners are outside all the beams of the beam lattice, i.e. all the corners are spaced by more than the beam radius at the relevant point from any considered beam axis. In examples, this may mean considering all the beams of the beam lattice model, or a sub-set of ‘candidate’ beams, such as those beams which intercept the ‘parent’ sub-volume as described above. If all the corners are external to all beams, the sub-volume is a candidate to be categorised as an exterior sub-volume, and a second test is carried out in block 310.

Block 310 comprises determining if a beam passes through the body of the sub-volume (without intercepting with the corners). For example, separating axis theorem may be used to seek a separating plane between the sub-volume (i.e. the parallelepiped defined by the corners) and the beam. If a separating plane is found, this implies that the sub-volume is empty of beams, and the sub-volume is an exterior sub-volume.

In other examples, testing for an intersection between a beam and the sub-volume may comprise selecting an array of points within the sub-volume under consideration and determining if these points are points within any beam (or any of the ‘candidate’ beams). For example, the points may be selected using a grid, or a Monte Carlo simulation, or the like. This provides an approximate solution, the accuracy of which may vary based on the spacing of the points, for example compared to the beam radii, and the like.

While such methods may be used to determine all intersections between beams and sub-volumes, they may be relatively computationally expensive (in particular if an array of points is tested) when compared to checking the corners, and therefore it may be intended to make use of such methods relatively sparingly, for example only when all the corners are found to be external to the beams.

However, if the second test determines that there are no beams which pass through the sub-volume, the sub-volume may be categorised as external in block 312.

If at least one corner is interior to a beam and at least one corner is exterior to a beam, or all corners are outside, but a beam intersecting the sub-volume is found in block 310, the sub-volume is categorised as a boundary sub-volume in block 314.

By considering the corners of each sub-volume, the sub-volumes may be quickly and systematically categorised. The use of the secondary test to determine more general intersections between the sub-volumes and the beams is carried out when all corners are outside a beam, but not in all cases, further streamlining categorisation.

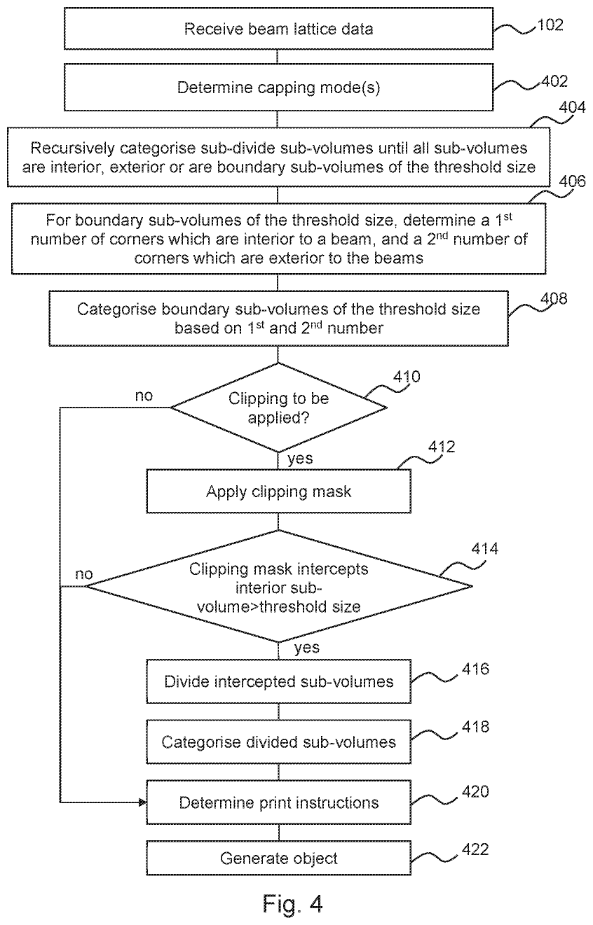

FIG. 4 is an example of a method determining a volumetric model and of generating an object, which starts with block 102 of FIG. 1.

In block 402, the method comprises determining, by processing circuitry, at least one capping mode of the beam lattice. For example, a capping mode, or “capmode” may be ‘butt’, ‘sphere’ or ‘hemisphere’. For a butt capping mode, a beam end will be closed with a flat end and therefore have a cylindrical shape if the beam is of consistent width (i.e.

both the vertices of the beam are associated with a specification of the same beam radius and have a butt capping mode), or frustro-conical shape if the beam is tapering (i.e. the vertices at either end of the beam are associated with a specification of different beam radii). For a sphere capping mode, a beam end will be closed at its end(s) (the location of which is determined by the vertices) by a sphere. For a hemisphere capping mode, a beam end will be closed at its end(s) by a half sphere. In some examples, each vertex may be associated with a capping mode independently, i.e. the same capping mode need not apply to all the vertices of a beam lattice and/or different ends of the same beam may have different capping modes. Therefore, block 404 may comprise determining a capping mode for each beam end.

The volumetric extent of the beams of the beam lattice is determined based on the capping mode of the (or each) vertex. In some examples, even where a capping mode is specified, this may be over-ridden at the junction between beams (i.e. where one vertex is an end of two beams), or the join may be a combination of both capping modes, and this may also be taken into account when determining the volumetric extent of the beams.

The method then proceeds, in block 404 with recursively categorising and sub-dividing sub-volumes until all sub-volumes are categorised as interior, exterior or are boundary sub-volumes of the threshold (minimum) size. This therefore includes the method of FIG. 2, and, in this example, the method of FIG. 3.

In this example, as the capping mode is taken into account, it is determined, for each corner, whether the corner is within a predetermined maximum radius of a vertex. The radius may be the radius associated with the vertex under consideration.

For corners which are within the radius, the process depends on the capping mode.

For example, if the capping mode is spherical, then all corners which are spaced from a vertex by a distance equal or less than the radius associated with that vertex are considered to be within the beam.

If the capping mode is hemispherical, a dot product of a vector between the corner and the vertex, d, and the vector indicating the axis of the beam, a, are determined. The dot product d.a will be negative if the vector d is at more than a 90° angle to the vector a indicating the axis of the beam. Therefore, if the dot product is negative, then the corner is considered to be within the beam if it is spaced by less than the radius from the vertex and otherwise the corner is considered to be outside the beam.

If the capping mode is butt, there is no extension to the basic specification of the beam, so no further volume need be considered.

The method then proceeds to block 406, which comprises, for the boundary sub-volumes of the threshold size (which may be print-resolution, or voxel, size), determining a first number of corners which are interior to a particular beam, and a second number of corners which are exterior to that beam. It may be the case that it is unlikely that no corners will coincide with the beam for a boundary sub-volume at this level of resolution.

The first and second number may be determined in either order, one being implicit based on the other, but may also be determined explicitly as each corner is ‘tested’ to determine if it is within or exterior to a beam volume. Block 408 comprises determining a categorisation of interior or exterior based on the first and second number. While this could be done on an arbitrary basis, for example, by categorising sub-volumes of the threshold size which at least partially coincide with a beam as interior sub-volumes, in this example, the number of corners in each category is considered. For example, if there are more external corners than internal corners, the sub-volume may be designated as external. If there are more internal corners (or an equal number of external and internal corners), the sub-volume may be designated as internal to the particular beam. However, other ratios may be used in other examples.

In other examples, the number of corners may not be taken into account when categorising boundary sub-volumes of the minimum size. For example, all such sub-volumes may be categorised as interior, as exterior, given a random categorisation, or remain categorised as boundary sub-volumes.

Block 410 comprises determining if the model is to be clipped. This may for example be indicated as a ‘clipping mode’. In some examples, there may be a clipping mode of ‘none’ indicating that no clipping is to take place, a clipping mode of ‘inside’, which constrains the beam lattice to a portion which is within a predetermined clipping mask volume, or a clipping mode of ‘outside’, which constrains the beam lattice to a portion which is outside a predetermined clipping mask volume. The clipping mask may for example be specified using a polygon mesh, or in some other way.

If the model is to be clipped, the method proceeds to block 412, which comprises applying the clipping mask. For example, an object may be intended to have a beam lattice interior, and a clipping mode of ‘inside’ may be set, wherein the shape of the clipping mask volume follows the contours of the object, for example being slightly smaller than the object to leave a solid outer ‘skin’. In another example, an object shape defined by a mesh model may be intended to be ‘packed’ in a beam lattice structure, in which case a clipping mode of ‘outside’ may be set, with the clipping mask having the shape of the object.

Block 414 comprises determining if the clipping mask has intercepted an interior sub-volume which is greater than the threshold size. As noted above, the clipping mask may be a polygon mesh and intersections may be determined using ‘separating axis theorem’. This tests to see if there is a line onto which projections of two potentially intersecting objects may extend without overlapping. If the projections do not overlap, the objects (for example a polygon of a mesh model and a sub-volume in this context) do not intersect. In other examples, testing for an intersection may comprise determining if the surface defined by the clipping mask intersects by selecting an array of points within the sub-volume under consideration and determining if these points are points within the surface. For example, the points may be selected using a grid, or a Monte Carlo simulation, or the like. This provides an approximate solution. Such methods may be relatively computationally expensive, and may be applied for example to clipping masks defined using mathematical models such as Non-uniform rational basis spline (NURBS), in which it may be difficult to determine intersections using less computationally expensive processes.

If there is an intersection between an interior sub-volume and the mask, the method proceeds to block 416 which comprises dividing the intercepted sub-volume into further sub-volumes and block 418 comprises categorising the further sub-volumes by determining if the further sub-volumes are wholly interior to the clipping mask, wholly exterior to the clipping mask or span a boundary of the clipping mask. In this case, the categorisation will also depend on the clipping mode such that sub-volumes which are interior to the mask may be categorised as exterior if the clipping mode is ‘outside’, and interior if the clipping mode is ‘inside’. This categorisation may be carried out iteratively, sub-dividing boundary sub-volumes until the threshold sub-volumes size is reached, in which case the method of FIG. 3 may be applied.

It may be noted that some sub-volumes may, as a result of this clipping process, be categorised and then effectively deleted, or will be re-categorised in a subsequent process. However, if the clipping were to occur before categorisation, this may result in the loss of vertices and their associated information, such as the radius of one end of the beam, and therefore the radius of the beam along its length.

Once the clipping and associated re-categorisation of sub-volumes is complete (or if the determination in block 410 or block 414 was negative), the method continues to block 420, which comprises determining print instructions for generating an object based on the categorised sub-volumes. In some examples, the print instructions may specify an amount of print agent to be applied to each of a plurality of locations on a layer of build material. For example, generating print instructions may comprise determining an amount of print agent (or no print agent) to be associated with each of the voxels of a slice of an object model corresponding to a layer of an object to be generated. Sub-volumes which are larger than print resolution voxels may be trivially divided into voxels, which will all have the same ‘interior’ or ‘exterior’ categorisation of the sub-volume itself. For example, if a voxel relates to a region of a fabrication chamber which is intended to solidify (an ‘interior’ voxel), the print instructions may be generated to specify that fusing agent should be applied to a corresponding region of build material in object generation. If however a voxel relates to a region of the fabrication chamber which is intended to remain unsolidified (an ‘external’ voxel), then print instructions may be generated to specify that no agent, or a coalescence modifying agent such as a detailing agent, may be applied thereto. In addition, the amounts of such agents may be specified in the print instructions and these amounts may be determined based on, for example, thermal considerations and the like.

The method further comprises, in block 422, generating an object using the print instructions.

Generating an object may comprise using print instructions generated as described above. For example, this may comprise forming a layer of build material, applying print agents, for example through use of ‘inkjet’ liquid distribution technologies in locations specified in the object model data for an object model slice corresponding to that layer using at least one print agent applicator, and applying energy, for example heat, to the layer. Some techniques allow for accurate placement of print agent on a build material, for example by using printheads operated according to inkjet principles of two-dimensional printing to apply print agents, which in some examples may be controlled to apply print agents with a resolution of around 600 dpi, or 1200 dpi. A further layer of build material may then be formed and the process repeated, for example with the object model data for the next slice of an object model.

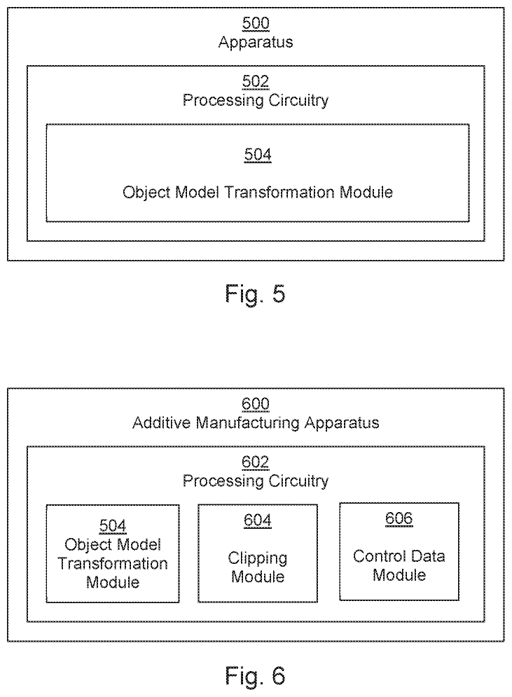

FIG. 5 shows an example of an apparatus 500 comprising processing circuitry 502, the processing circuitry 502 comprising an object model transformation module 504.

In use of the apparatus 500, the object model transformation module 504 transforms a data model of a three-dimensional object to be generated from a first model defined (at least in part) using a beam lattice to a second model defined using a plurality of contiguous, non-overlapping sub-volumes. In particular, the object model transformation module 504 recursively sub-divides a virtual volume containing the first model until the sub-volumes thereof can be categorised as: (i) interior sub-volumes, which are wholly within a beam of the beam lattice; (ii) exterior sub-volumes which are wholly outside the beams of the beam lattice; or (iii) sub-volumes having a predetermined minimum size (e.g. print resolution size sub-volumes). In some examples, the object model transformation module 504 categorises each sub-volume by determining if the corners thereof are interior or exterior to the beams, as described in greater detail above. In some examples, the object model transformation module 504 is to determine if any beams intersect the sub-volume and, if not, to categorise the sub-volume as an exterior sub-volume. In some examples, the object model transformation module 504 categorises each sub-volume by determining a volumetric extent of the beam(s) based on a capping mode associated with the beam and determining intersections based on the volumetric extent of the beam.

The object model transformation module 504 may for example carry out any or any combination of the blocks of FIG. 1, 2 or 3, and/or block 404-418 of FIG. 4.

FIG. 6 shows an example of an additive manufacturing apparatus 600 comprising processing circuitry 602, the processing circuitry 602 comprising the object model transformation module 504, a clipping module 604 and a control data module 606.

In use of the apparatus 600, the clipping module 604 may applies a boundary, or clipping, mask to the sub-volumes to remove a portion of the model and, where the boundary mask intercepts an interior sub-volume (having a size greater than the threshold size), the object model transformation module 504 divides and categorises the intercepted sub-volume, for example as set out in relation to blocks 414 to 418 above.

In use of the apparatus 600, the control data module 606 determines additive manufacturing apparatus control data to generate an object from the categorised sub-volumes, for example as described in relation to the determination of print instructions as set out in relation to block 420 above.

The apparatus 600, in use thereof, may generate the object in a plurality of layers (which may correspond to respective slices of an object model) according to object generation instructions. The apparatus 600 may for example generate an object in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. In other examples, heat may be selectively applied, and/or chemical agents such as curing or binding agents may be applied. The apparatus 600 may comprise additional components not shown herein, for example any or any combination of a fabrication chamber, a print bed, printhead(s) for distributing print agents, a build material distribution system for providing layers of build material, energy sources such as heat lamps and the like.

The apparatus 600, processing circuitry 602, or the modules thereof may carry out any or any combination of the blocks of FIGS. 1-4.

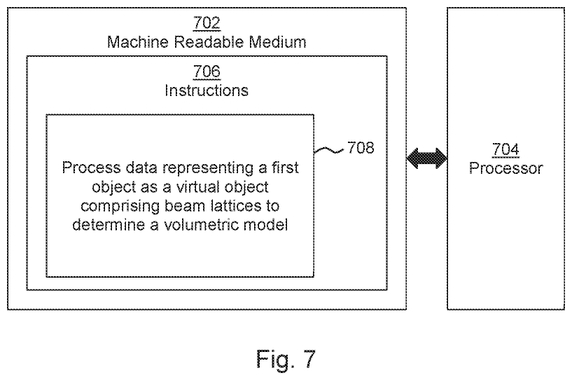

FIG. 7 shows a tangible machine-readable medium 702 associated with a processor 704. The machine-readable medium 702 comprises instructions 706 which, when executed by the processor 704, cause the processor 704 to carry out tasks. In this example, the instructions 706 comprise instructions 708 to cause the processor 704 to process data representing a first object as a virtual object comprising (at least in part) a beam lattice to determine a volumetric model of the virtual object, wherein the volumetric model of the virtual object is described using a plurality of sub-volumes by classifying each sub-volume as one of an interior sub-volume and a boundary sub-volume if a beam of the virtual object intersects with the region defined by the sub-volume; and if the sub-volume is a boundary sub-volume of above a threshold size, to subdivide the sub-volume and classify the subdivided sub-volumes. The instructions 706 may further comprise instructions to cause sub-volumes with no intersections with a beam to be classified as exterior sub-volumes.

The machine readable medium 702 may comprise instructions to cause the processor 704 to carry out any or any combination of the blocks of FIG. 1-3, or block 402 to 420 of FIG. 4, and/or to act as any part of the processing circuitry 502, 602 of FIG. 5 or 6.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices such as the object model transformation module 504, clipping module 604 and/or control data module 606 may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors,

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving, at processing circuitry, beam lattice data modelling at least part of a three-dimensional object to be generated using additive manufacturing as a beam lattice;
determining, using processing circuitry, a volumetric data model from the beam lattice data, wherein determining the volumetric data model comprises:
dividing a volume containing the beam lattice data into sub-volumes; and
categorising the sub-volumes into:
interior sub-volumes, which are wholly within a beam of the beam lattice;
exterior sub-volumes which are wholly outside the beams of the beam lattice; and
boundary sub-volumes which partially coincide with a beam of the beam lattice; the method further comprising:
subdividing boundary sub-volumes and categorising the subdivided sub-volumes until a threshold volume size of boundary sub-volume is reached.

2. A method according to claim 1 wherein categorising the sub-volumes comprises determining, for each corner of the sub volume, if the corner coincides with a beam of the beam lattice wherein the method comprises;
if all the corners thereof are interior to a given beam, categorising the sub-volume as an interior sub-volume;
if all the corners thereof are outside the beams of the beam lattice, determining if any beams intersect with the volume of the sub-volume, and if not, categorising the sub-volume as an exterior sub-volume; and
if at least one corner is interior to a beam and at least one corner is exterior to that beam, or if all corners are outside the beams of the beam lattice and at least one beam intersects with the volume of the sub-volume, categorising the sub-volume as a boundary sub-volume.

3. A method according to claim 1 further comprising:
categorising boundary sub-volumes of the threshold size as interior or exterior sub-volumes by determining a first number of corners which are interior to a beam, and a second number of corners which are exterior to the beams, and determining the categorisation based on the first and second number.

4. A method according to claim 1 further comprising determining a capping mode of the beam lattice and wherein a volumetric extent of the beams of the beam lattice used in determining which sub-volumes are wholly within a beam of the beam lattice, which sub-volumes are wholly outside the beams of the beam lattice and which sub-volumes partially coincide with a beam of the beam lattice is determined based on the capping mode.

5. A method according to claim 1 further comprising determining if the model is to be clipped and, if so to apply a clipping mask to the volumetric model to remove a portion of the model; and
where the clipping mask intercepts an interior sub-volume which is greater than the threshold size the method further comprises:
dividing the intercepted sub-volume into further sub-volumes and categorising the further sub-volumes by determining if the further sub-volumes are wholly interior to the clipped model, wholly exterior to the clipped model or span a boundary of the clipped model.

6. A method according to claim 1 further comprising determining print instructions for generating an object based on the categorised sub-volumes.

7. A method according to claim 6 further comprising generating an object using the print instructions.

8. An apparatus comprising processing circuitry, the processing circuitry comprising:
an object model transformation module to transform a data model of a three-dimensional object to be generated from a first model defined using a beam lattice to a second model defined using a plurality of contiguous, non-overlapping sub-volumes; wherein the object model transformation module is to recursively sub-divide a virtual volume containing the first model until the sub-volumes thereof can be categorised as:
interior sub-volumes, which are wholly within a beam of the beam lattice;
exterior sub-volumes which are wholly outside the beams of the beam lattice; or
sub-volumes having a predetermined minimum size.

9. An apparatus according to claim 8 further comprising a clipping module wherein the clipping module is to apply a boundary mask to the sub-volumes to remove a portion of the model and, where the boundary mask intercepts an interior sub-volume,
the object model transformation module is to divide and categorise the intercepted sub-volume.

10. An apparatus according to claim 8 wherein the object model transformation module is to categorise each sub-volume by determining if the corners thereof are interior or exterior to the beams.

11. An apparatus according to claim 10 wherein, when all the corners of a sub volume are exterior to the beams, the object model transformation module is to determine if any beams intersect the sub-volume and, if not, to categorise the sub-volume as an exterior sub-volume.

12. An apparatus according to claim 8 wherein the object model transformation module is to categorise each sub-volume by determining a volumetric extent of a beam based on a capping mode associated with the beam.

13. Apparatus according to claim 8 further comprising a control data module to determine additive manufacturing apparatus control data to generate an object from the categorised sub-volumes.

14. Apparatus according to claim 13 further comprising additive manufacturing apparatus to generate at least one object using the additive manufacturing apparatus control data.

15. Tangible machine-readable medium storing instructions which, when executed by a processor, cause the processor to:
process data representing a first object as a virtual object comprising a beam lattice to determine a volumetric model of the virtual object, wherein the volumetric model of the virtual object is described using a plurality of sub-volumes by classifying each sub-volume as one of an interior sub-volume and a boundary sub-volume if a beam of the virtual object intersects with the region defined by the sub-volume; and
if the sub-volume is a boundary sub-volume of above a threshold size, to subdivide the sub-volume and classify the subdivided sub-volumes.
